(19) United States
(12) Patent Application Publication
(10) Pub. No.: US 2017/0306673 A1
(43) Pub. Date: Oct. 26, 2017

(54) Device and method to restore hinge function to a malfunctioning or inoperable hinge

(71) Applicant: Jerry Raymond Spangler, Titusville, FL (US)

(72) Inventor: Jerry Raymond Spangler, Titusville, FL (US)

(21) Appl. No.: 15/494,180

(22) Filed: Apr. 21, 2017

Related U.S. Application Data
(60) Provisional application No. 62/326,481, filed on Apr. 22, 2016.

(51) Int. Cl. E05D 11/00

(52) U.S. Cl. CPC E05D 11/00; E05Y 2201/00; E05Y 2900/531

(57) ABSTRACT

A device and method that relate to restoring function and operation to a malfunctioning or inoperable hinges by attaching a flexible resilient material to the malfunctioning or inoperable hinge when the function and/or operation of a partially broken hinge pin spring and/or the function and/or operation of a partially broken hinge interlocking leaf or leaves cause the hinge to malfunction when the hinge is used to connect an out-swinging closure to a fixed structure.

### CROSS REFERENCES TO RELATED APPLICATIONS

This application claims the benefit of U.S. Provisional Application No. 62/326,481, filed 22 Apr. 2016.

### STATEMENT REGARDING FEDERALLY SPONSORED RESEARCH OR DEVELOPMENT

Not applicable.

### REFERENCE TO SEQUENTIAL LISTING, ETC.

Not applicable.

### BACKGROUND OF THE INVENTION

### Field of Invention

The present invention relates to hinges and, in particular, to a device and method for restoring function and operation to malfunctioning or inoperable hinges by using stretchable resilient material. At least in one embodiment, for example, the present invention relates to the repair (i.e. restoration of function and operation) of hinges in vehicles. [The words/phrases “repair” and “restoration of function and operation” are herein used interchangeably.]

### Description of the Related Art

Many hinges are made as a part of a larger compartment and cannot be replaced without replacing the entire compartment.

Many hinges today are made of non-durable materials and break after repeated use. For example, some hinges are made with holes through hard plastic, making the hinge leaves, and a metal rod as a hinge pin. The plastic has a tendency to break with repeated use. In addition, in order to be self-closing, many hinges have a second mechanism such as a torsion spring.

There are many automotive parts made of plastic that open and close via a hinge. Sometimes the hinge can be removed separately from the compartment while other times the hinge is part of the compartment. Many times these hinges are not reliable over time. Standard practice is to remove and replace the hinge or replace the entire compartment housing the hinge. In either case, the cost of labor and parts to repair or replace those hinges or the compartment which incorporates the hinge is expensive.

In one embodiment, my device and method could be used to restore function and operation to a malfunctioning, inoperable, partially broken hinge pin spring and/or partially broken hinge interlocking leaf or leaves on a variety of vehicles. For example, in one embodiment my device and method can be used to restore function and operation to a malfunctioning, inoperable, partially broken hinge pin spring and/or partially broken hinge interlocking leaf or leaves on a Mercedes Benz SL, years 2003-2012, R230 body style [hereinafter Mercedes Benz SL], right and/or left rear edge cover trim panel (passenger side/driver side) [hereinafter trim panel].

The Mercedes Benz SL, as well as other vehicles, has a trim panel that has a non-movable portion [hereinafter panel] and a hinged portion [hereinafter flap]. The flap is designed to open when the convertible hard-top is up and close when the convertible hard top is stored in the trunk.

When the panel hinge leaf/leaves or spring used to close the hinged door is partially broken or inoperable, the conventional way of restoring function and operation to the malfunctioning, inoperable, partially broken hinge pin spring and/or partially broken hinge interlocking leaf or leaves of the trim panel is to remove and replace the entire trim panel, because the hinge leaves are incorporated as part of the panel and not sold as a separate part.

In one embodiment, the invention restores function and operation to a malfunctioning, inoperable, partially broken hinge pin spring and/or partially broken hinge interlocking leaf or leaves of the Mercedes Benz SL as well as other vehicles.

In one embodiment, the invention restores the function and operation of the Mercedes Benz SL trim panel without removing or replacing any parts that comprise the trim panel.

It should be understood that the detailed description and specific examples, while indicating exemplary embodiments of the invention, are intended for purposes of illustration only and are not intended to limit the scope of the invention

### SUMMARY OF THE INVENTION

It is the primary objective of an embodiment of this present invention to restore function and operation of all types of hinges by attaching stretchable resilient material to the hinge without the necessity of replacing the hinge or, in the case where a hinge is incorporated as a part within a unit or compartment, without the necessity of replacing the unit or compartment in order to replace the hinge.

An embodiment of the present invention results in hinges becoming self-closing, regardless of whether the hinges were previously self-closing.

It is an objective of an embodiment of this invention to increase the life of hinges at a minimal cost.

It is an objective of an embodiment of this invention to serve as an alternative to removing inoperable or malfunctioning hinges.

It is an objective of an embodiment of this invention to serve as an alternative to removing units, compartments or the like, in order to replace or repair an inoperable or malfunctioning hinge.

An embodiment of this invention attaches in any manner resilient material to a malfunctioning or inoperable hinge, making the hinge fully operational and making the hinge self-closing, whether or not the hinge was previously self-closing.

An embodiment of this present invention utilizes self-adhesive resilient material.

An embodiment of this invention uses self-adhesive double-sided tape applied to one side of the resilient material.

An embodiment of this invention makes the resilient material self-adhesive by coating one side of the resilient material with a bonding solution or adhesive, or by using brackets, screws, rivets or channels to attach the resilient material.

An embodiment of this invention uses self-adhesive resilient material adapted to be stretched in the direction of its width, i.e. the direction that is perpendicular to the interlocking hinge pin leaf/leaves. By adhering the resilient material to a malfunctioning or inoperable hinge, one embodiment of this invention makes the hinge fully operational and makes the hinge self-closing, whether or not the hinge was self-closing prior to

In one embodiment of this invention the amount of tension is dependent upon the particular amount of tension necessary to effect closure.

In one embodiment of this invention, as one skilled in the art knows, the pounds of force resistance and thickness and dimensions of the resilient material are dependent on the particular size and specification of the hinge leafs and hinge plates.

In one embodiment of this invention, one of more components as described herein may be provided as a repair kit.

Various materials may be used in addition to those components described herein to enhance functionality of the invention.

In another embodiment, my device and method could be used to restore function and operation of a non-operable, partially broken hinge pin spring on doors and closures.

Referring to the device in FIG. 1 and FIG. 2, as well as the mirror images of FIG. 1 and FIG. 2 (not shown), and the method of repair, one embodiment of this invention, repairs the function and operation of the Mercedes Benz SL trim panel without removing or replacing any parts that comprise the trim panel.

The above summary of the present invention is not intended to describe each embodiment or every implementation of the present invention. One or more features of each of the embodiments may be modified and still perform the same functionality or additional functionality without departing from the scope of the present invention.

### BRIEF DESCRIPTION OF THE DRAWINGS

Many aspects of the present embodiments can be better understood with reference to the following drawings. The components in the drawing are not necessarily drawn to scale, the emphasis instead being placed upon illustrating the principles of the present embodiments. It is to be understood that the drawings are to be used for the purposes of illustration only and not as a definition of the limits of the preferred embodiments. Various modifications of the illustrative embodiments, as well as additional embodiments of the invention, will be apparent to persons skilled in the art upon reference to this description.

In the preferred embodiment of this invention:

FIG. 1 is a top view of the face of the cut to size and shape flexible resilient material that does not adhere or attach to any portion of the hinge that is being repaired.

FIG. 2 is the bottom view of the face of the cut to size and shape flexible resilient material with the double sided tape adhered to the cut to size and shape flexible resilient material and is later adhered to the hinge that is being repaired.

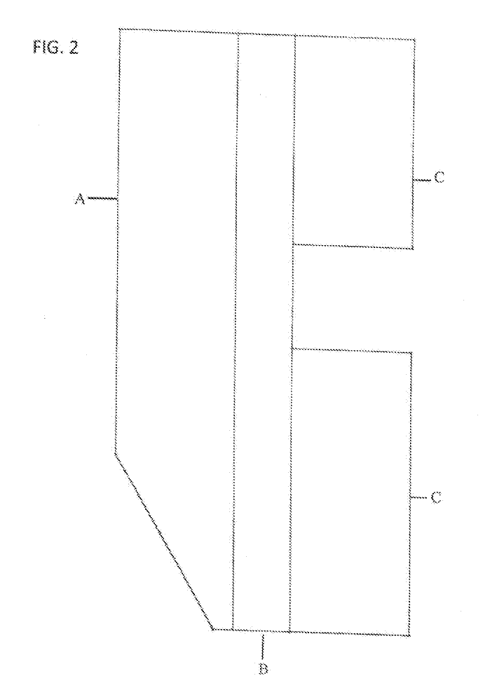

Referring to FIG. 2, sections A and C show the face of the cut flexible resilient material specific locations where the double sided tape is applied to the flexible resilient material. Referring to FIG. 2, sections A and C of the flexible resilient material will adhere to a hinge that is to be repaired.

Referring to FIG. 2, section A depicts one side of the double sided tape attached to a section of the flexible resilient material. When the hinge is being repaired, Section A will attach parallel to the hinge's interlocking hinge pin leaves without attaching to the interlocking hinge pin leaves.

Referring to FIG. 2, B depicts the middle section of the flexible resilient material where no double sided tape is applied.

Referring to FIG. 2, sections C show where additional double sided tape is attached to the flexible resilient material. When the function and operation of a hinge is being restored, sections C will attach parallel to but without adhering to the interlocking hinge pin leaves.

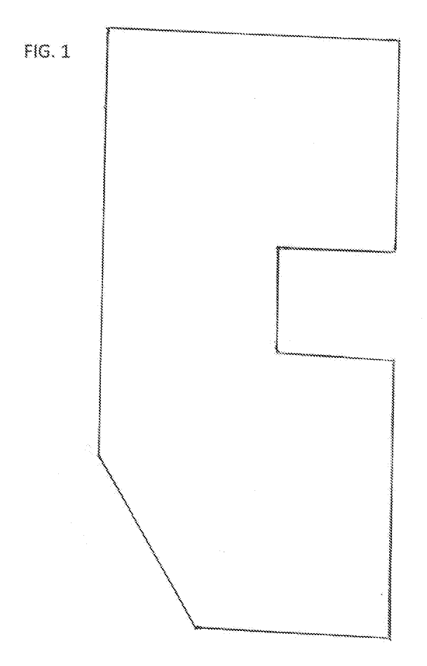

Referring to FIG. 1 and FIG. 2, mirror images of FIG. 1 and FIG. 2 (not shown) may be used as appropriate.

### DETAILED DESCRIPTION OF THE PREFERRED EMBODIMENTS

The following description of certain exemplary embodiments is exemplary in nature and is not intended to limit the invention, its application, or uses. The components in the drawings are not necessarily drawn to scale.

Referring to FIG. 1, this invention is made by cutting a sheet of flexible resilient material to a specific size and shape as determined by measuring the hinge to be repaired as follows:

The length of the flexible resilient material is best determined by measuring the inoperable hinge's length and shape parallel to the interlocking hinge pin leaves.

The width of the flexible resilient material is best determined by measuring the entire width of the inoperable hinge perpendicular to the hinge pin leaves and subtracting the measured distance of the interlocking hinge pin leaves.

The width of the flexible resilient material will be shorter than the entire width of the hinge. It is best that the flexible material is shorter in width than the hinge's width so that when flexible resilient material is stretched and adhered to the hinge being repaired, the flexible resilient material applies enough pressure over the interlocking hinge pin leaves to hold the interlocking hinge pin leaves together and make the hinge self-closing.

FIG. 1 shows the top side of the cut to size and shape flexible resilient material. FIG. 1, the top side, does not adhere or attach to any portion of the hinge or anything else.

FIG. 2 is the opposite side of FIG. 1. FIG. 2 is the cut to size and shape flexible resilient material with the double sided tape adhered to sections A and C. FIG. 2 side of the invention will attach to the inoperable hinge, making the inoperable hinge operable.

There are many methods for attaching the flexible resilient material to the partially broken or inoperable hinge. Methods include, but are not limited to: double sided tape, adhesive products, mechanical methods, screws, rivets, brackets, tracks, etc. The lengths and widths of adhesives, such as double sided tape, may be varied depending on the need.

In the preferred embodiment the flexible resilient material is attached to the inoperable hinge by using double sided tape, which has peelable liners protecting the tape.

FIG. 2, sections A and C show specific locations where the double sided tape is positioned. The double sided tape in this preferred embodiment cover the surfaces of sections A and C.

FIG. 2, section A shows the location where one side of the double sided tape is attached to the flexible resilient material. Peel the liner from one side of the double sided tape exposing the adhesive of one side of the double sided tape. Attach the adhesive side of the double sided tape to section A, of FIG. 2. The double sided tape in the preferred embodiment covers the surface of section A. When the hinge repair is complete, section A will be parallel to the inoperable hinge's interlocking hinge pin leaves.

FIG. 2, section B shows a middle section of the flexible resilient material. Tape is not applied to Section B.

FIG. 2, sections C show the location where double sided tape is attached to sections C of the flexible resilient material. Peel the liner from one side of the double sided tape exposing the adhesive of one side of the double sided tape. Attach the adhesive side of the double sided tape to sections C, of FIG. 2. When the hinge repair is complete, sections C will be parallel to the hinge's interlocking hinge pin leaves.

The next step is to attach the flexible resilient material to the inoperable hinge.

Remove the protective peelable liner from the double sided tape, exposing the adhesive portion of the double side tape from the double sided tape shown in FIG. 2, section A.

Adhere the flexible resilient material to the inoperable hinge perpendicular to the inoperable hinge's interlocking hinge pin.

Remove the protective peelable liner from the double sided tape, exposing the adhesive portion of the double side tape from the double sided tape shown in FIG. 2, sections C. Stretch the resilient material over and parallel to the interlocking hinge pin leaves and, while stretched, adhere the flexible resilient material as shown in FIG. 2, sections C, to the other entire length of the hinge without attaching it to the interlocking hinge pin leaves.

In one embodiment, FIG. 1 and FIG. 2 device and method restore the function and operation of the Mercedes Benz SL passenger side trim panel without removing or replacing any parts that comprise the trim panel.

In one embodiment, the mirror images of FIG. 1 and FIG. 2 (not shown) device and method restore the function and operation of the Mercedes Benz SL driver side trim panel without removing or replacing any parts that comprise the trim panel.

What is claimed is:

1. Device and method for restoring function and operation to a malfunctioning, inoperable, or partially broken hinge spring when the function and/or operation of a partially broken hinge pin spring and/or a partially broken hinge interlocking leaf or leaves cause the hinge to malfunction or be inoperable, while the hinge is used to connect an out-swinging closure to a fixed structure comprising of but not limited to:
the device which is comprising of resilient material such as rubber, latex, elastic, or other stretchable material;
comprising of sections of the resilient material covered with double sided tape or other adhesive product or attaching methods;
comprising of a section of the resilient material that does not adhere to anything;
stretching under tension the device over the hinge pin and interlocking leaf or leaves of the malfunctioning or inoperable hinge;
and while stretching the device and placing the device under tension, adhering or attaching the device to both the closure and structure or to both hinge plates by means of double sided tape, glue, or other adhesive product, or other attaching methods, while ensuring that the device is not adhered or attached to the hinge pin nor adhered or attached to the interlocking leaf or leaves; and
making the malfunctioning or inoperable hinge function and operate properly.

2. Device and method for repairing a malfunctioning, inoperable hinge, or partially broken hinge pin spring on a Mercedes Benz SL, years 2003-2012, R230 body style, right and/or left rear edge cover trim panel, comprising of:
the device which is comprising of resilient material such as rubber, latex, elastic, or other stretchable material;
comprising of sections of resilient material covered with double sided tape or other adhesive product or other attaching methods;
comprising of a section of the resilient material that does not adhere or attach to anything;
stretching under tension the device over the hinge pin and interlocking leaf or leaves of the malfunctioning, inoperable hinge, or partially broken hinge pin spring;
and while stretching the device and placing the device under tension, adhering or attaching the device to both the closure and structure or to both hinge plates by means of double sided tape, glue, adhesive product, or other attaching means while ensuring that the device is not adhered or attached to the hinge pin spring nor adhered or attached to the interlocking leaf or leaves; and
making the malfunctioning or inoperable hinge function and operate properly.

3. Device and method for restoring function and operation to a malfunctioning, inoperable, or partially broken hinge pin spring when the function and/or operation of a partially broken hinge pin spring and/or a partially broken hinge interlocking leaf or leaves cause the hinge to malfunction or be inoperable, while the hinge is used to connect an out-swinging closure to a fixed structure comprising of but not limited to:
the device which is comprising of resilient material such as rubber, latex, elastic, or other stretchable material;
comprising of sections of the resilient material that are attached by mechanical attachment methods;
comprising of a section of the resilient material that does not adhere or attach to anything;
stretching under tension the device over the hinge pin spring and interlocking leaf or leaves of the malfunctioning or inoperable hinge;
and while stretching the device and placing the device under tension, adhering or attaching the device to both the closure and structure or to both hinge plates by mechanical methods while ensuring that the device is not adhered or attached to the hinge pin nor adhered or attached to the interlocking leaf or leaves; and
making the malfunctioning or inoperable hinge function and operate properly.
